(19) United States
(12) Patent Application Publication
(10) Pub. No.: US 2023/0365778 A1
(43) Pub. Date: Nov. 16, 2023

(54) Catalytic process for selective polyolefin hydrogenolysis

(71) Applicants: Alliance for Sustainable Energy, LLC, Golden, CO (US); Massachusetts Institute of Technology, Cambridge, MA (US)

(72) Inventors: Yuriy ROMÁN, Cambridge, MA (US); Julie RORRER, Cambridge, MA (US); Guido ZICHITTELLA, Cambridge, MA (US); Gregg Tyler BECKHAM, Golden, CO (US)

(21) Appl. No.: 18/314,919

(22) Filed: May 10, 2023

Related U.S. Application Data
(60) Provisional application No. 63/340,322, filed on May 10, 2022.

(51) Int. Cl. C08J 11/16; B01J 29/40

(52) U.S. Cl. CPC C08J 11/16; B01J 29/40; C08J 2300/30; C08J 2323/06; C08J 2323/12

(57) ABSTRACT

What is disclosed herein is a method for depolymerizing polyolefins, comprising
a. preparing a catalyst comprising cobalt, nickel or both;
b. combining the catalyst with a sample comprising polyolefins in a reaction vessel in the presence of H₂ gas to produce a mixture, wherein the polyolefin comprises a carbon chain having the structure (CH₂CHR)ₙ wherein R is an alkyl group and n is an integer greater than 20;
c. reacting the mixture under conditions effective to depolymerize the polyolefins to produce decomposition products, wherein the decomposition products comprise the structure (CH₂CHR)ₘ wherein m is an integer much less than n.

### CROSS-REFERENCE TO RELATED APPLICATIONS

This application claims priority from U.S. Provisional Patent Application No. 63/340,322 filed on May 10, 2023, the contents of which are incorporated herein by reference in their entirety.

### STATEMENT REGARDING FEDERALLY SPONSORED RESEARCH OR DEVELOPMENT

This invention was made with government support under grant number DE-AC3608GO28308 awarded by U.S. Department of Energy, Advanced Manufacturing Office and Bioenergy Technologies Office. The government has certain rights in this invention.

### BACKGROUND

Plastic waste represents one of the most pressing problems of modern society, as over 5,000 million tons have been landfilled or leaked into the environment since the 1950s. Polyethylene (PE) and polypropylene (PP), the two most produced plastics worldwide, account for over half of this waste by weight. While mechanical recycling can process only a fraction of plastic waste, chemical recycling could convert it into processible products that can be reintegrated into a circular polymer economy. However, a key challenge lies in activating the strong and inert C—C bonds of the PE and PP backbones.

Among the different strategies reported to this end, hydrogenolysis, which utilizes H₂ to cleave the polymer into shorter alkanes, is a promising approach to deconstruct PE and PP under moderate conditions. Notably, platinum- and ruthenium-based catalysts have been shown to convert model polymers and post-consumer polyolefin plastics into liquid alkanes (C₇-C₂₀₊). To date, these catalytic systems often require high loadings of precious metals (up to 6 wt. %) and typically produce a wide array of products ranging from CH₄ and other light alkanes to liquid paraffins (C₇-C₂₄) and solid waxes (C₂₅₊), which stems from the internal C—C bond cleavage mechanism favored in these systems. The development of catalysts that are not based on precious metals and that promote narrower product distributions would enable more efficient technologies to valorize plastic waste. This would require catalysts adept at selectively cleaving the C—C bonds positions in the polyolefin chain that are non-terminal, thus minimizing generation of undesired CH₄, but near the chain end, forming a limited range of hydrocarbons, such as ethane, propane, and butane. These could be readily converted into the corresponding olefins and H₂ by commercial, scalable dehydrogenation technologies, thereby regenerating the monomers and closing both the carbon and hydrogen loop in PE and PP production (FIG. 1).

There is a need for an economical method of converting waste plastic into higher-value products at low temperatures and using less expensive catalysts.

### SUMMARY

This Summary introduces a selection of concepts in simplified form that are described further below in the Detailed Description. This Summary neither identifies key or essential features, nor limits the scope, of the claimed subject matter.

One aspect of the disclosure herein is a method for depolymerizing polyolefins, comprising (a) preparing a catalyst comprising cobalt, nickel or both; (b) combining the catalyst with a sample comprising polyolefins in a reaction vessel in the presence of H₂ gas to produce a mixture, wherein the polyolefin comprises a carbon chain having the structure (CH₂CHR)ₙ, wherein R is an alkyl group and n is an integer greater than 20; and (c) reacting the mixture under conditions effective to depolymerize the polyolefins to produce decomposition products, wherein the decomposition products comprise the structure (CH₂CHR)ₘ, wherein m is an integer much less than n.

In one embodiment of the method disclosed herein, the sample comprises plastic material. In one embodiment, the plastic material comprises at least one selected from the group consisting of plastic film, plastic foam, plastic packaging, plastic bags, plastic wrap, and combinations thereof. In one embodiment, the plastic material comprises polyethylene or polypropylene.

In one embodiment of the method disclosed herein, the decomposition products comprise a carbon chain having the structure (CH₂CH₂)ₙ.

In one embodiment of the method disclosed herein, the decomposition products comprise a carbo chain having the structure (CH₂CH(CH₃))ₙ.

In one embodiment of the method disclosed herein, the decomposition products consist of a high selectivity towards selected light alkanes.

In one embodiment of the method disclosed herein, more than 50%, 60%, 70%, or 80% of the decomposition products comprise a carbon chain having the structure (CH₂CH₂)ₙ.

In one embodiment of the method disclosed herein, more than 50%, 60%, 70%, or 80% of the decomposition products comprise a carbon chain having the structure (CH₂CH(CH₃))ₙ.

In one embodiment of the method disclosed herein, less than 30%, 25%, 20%, 25%, 15%, or 10% of the decomposition products consist of methane.

In one embodiment of the method disclosed herein, the catalyst comprises cobalt and/or nickel supported by a zeolite carrier.

In one embodiment of the method disclosed herein, the catalyst comprises cobalt and/or nickel supported by a pentasil-zeolite carrier.

In some embodiments, the catalyst comprises both cobalt and nickel. For example, the catalyst may comprise greater than 2 wt %, 3 wt %, 5 wt %, 7 wt %, 10 wt % or 15 wt % of both cobalt and nickel.

In one embodiment of the method disclosed herein, the cobalt catalyst comprises ZSM-5, FAU, BEA, MOR or a combination thereof.

In one embodiment of the method disclosed herein, the conditions effective to depolymerize the polyolefins to produce decomposition products comprise a temperature range of 300-600 K, 400-600 K, 350-600 K, or 350-550 K.

In one embodiment of the method disclosed herein, the conditions effective to depolymerize the polyolefins to produce decomposition products comprise an initial H₂ pressure of 1-100 bar, 10-100 bar, 20-60 bar, or 30-50 bar.

In one embodiment of the method disclosed herein, the conditions effective to depolymerize the polyolefins to produce decomposition products comprise a batch process with a residence time in the reaction vessel of 1-100 hours, or 5-50 hours.

In one embodiment of the method disclosed herein, the conditions effective to depolymerize the polyolefins to produce decomposition products comprise a continuous process. In one embodiment, the continuous process comprises a continuous addition of sample to the reaction vessel in (b) and a continuous removal of the decomposition products in (c).

In one embodiment of the disclosure herein, the method further comprises isolating the decomposition products.

The following Detailed Description references the accompanying drawings which form a part this application, and which show, by way of illustration, specific example implementations. Other implementations may be made without departing from the scope of the disclosure.

### BRIEF DESCRIPTION OF THE DRAWINGS

FIG. 1 shows a simplified scheme of the envisioned closed-loop polyolefin cycle. This involves catalytic hydrogenolysis of waste plastic at close-to-terminal C—C bonds to generate light alkanes, i.e., ethane, propane, butane, which can then be dehydrogenated into the corresponding olefins and H₂ by commercial technologies.

FIGS. 2a and 2b show mass-based a) phase distribution of products and molar H₂ conversion and b) gas composition at ca. 5 mol. % H₂ conversion in the hydrogenolysis of PE over the supported cobalt-based catalysts. Conditions: a,b) T=523 K, P=40 bar H₂, W_{M}=50 mg, a) t=20 h; b) t=5-40 h

FIG. 3a-3d show transmission electron microscopy of Co/ZSM-5 a) prior to and b) after PE hydrogenolysis. c) Temperature-programmed reaction with H₂ and d) experimental FT-EXAFS spectra at the Co K-edge of Co/ZSM-5 and Co₃O₄ prior to (fresh, black) and after PE hydrogenolysis (used, red). Fits with imaginary components are plotted for fresh (gray, blue, and green lines) and used (pink, orange, and yellow lines) Co/ZSM-5 and were performed using a k range of 2.0-10.0 Å⁻¹ and an R range of 1.0-2.1 Å. Conditions: T=523 K, P=40 bar H₂, W_{M}=50 mg, t=20 h.

FIG. 4a-4b show mass-based a) phase distribution of products and molar H₂ conversion as well as b) CH₄ and C₃H₈ selectivity as a function average particle size, dₚ, in the hydrogenolysis of PE over ZSM-5-supported cobalt-based catalysts with different metal loadings. Conditions: T=523 K, P=40 bar H₂, W_{M}=50 mg, t=20 h.

FIG. 5a-5b show mass-based a) phase distribution of products and molar H₂ conversion and b) gas composition in the hydrogenolysis of LDPE, PP, LDPE+PE, and post-PE over 10-Co/ZSM-5. Conditions: T=523 K, P=40 bar H₂ (35 bar H₂ for post-PE), W_{M}=50 mg, t=40 h (50 h for post-PE).

FIG. 6 illustrates activity of 10 wt % Co and Ni supported on zeolite frameworks.

FIG. 7 shows selectivity of 10 wt % Co and Ni supported on zeolite frameworks.

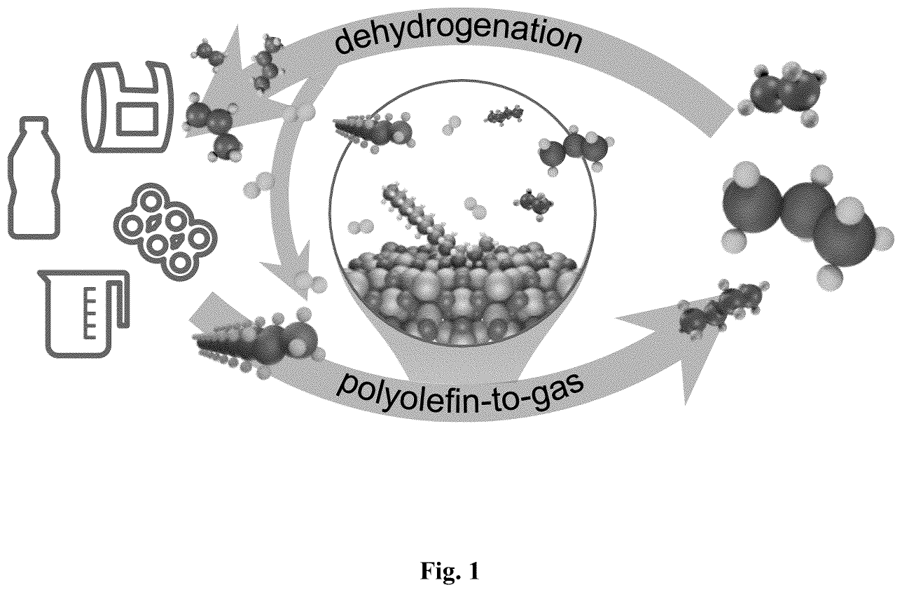

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

Reference numbers in superscripts herein refer to the corresponding literature listed in the attached Bibliography which forms a part of this Specification, and the literature is incorporated by reference herein.

To identify a catalyst with the aforementioned properties and reactivity, the solvent-free hydrogenolysis of n-tetracosane (n-C₂₄H₅₀), an oligomer of PE, was first investigated in a batch reactor, as discussed in detail in the Supporting Information. Among the different bulk metal oxides screened, cobalt oxide (Co₃O₄) was found to be highly active, fully converting the paraffin substrate into almost exclusively CH₄. Given these results, Co₃O₄ was tested for the batch solvent-free hydrogenolysis of PE and PP with mass average molecular weights (M_{W}) of 4,000 Da and 12,000 Da, respectively. After 20 h at 523 K and 40 bar of H₂, both polymers could be fully converted into CH₄ over 100 mg of Co₃O₄. The dominant products across temperatures, reaction times, and catalyst loadings tested over Co₃O₄ were solids or gases, with gaseous products comprised exclusively of CH₄. Under all conditions investigated, only trace liquid products were formed. These observations support the hypothesis that Co₃O₄ favors a terminal C—C bond cleavage mechanism.

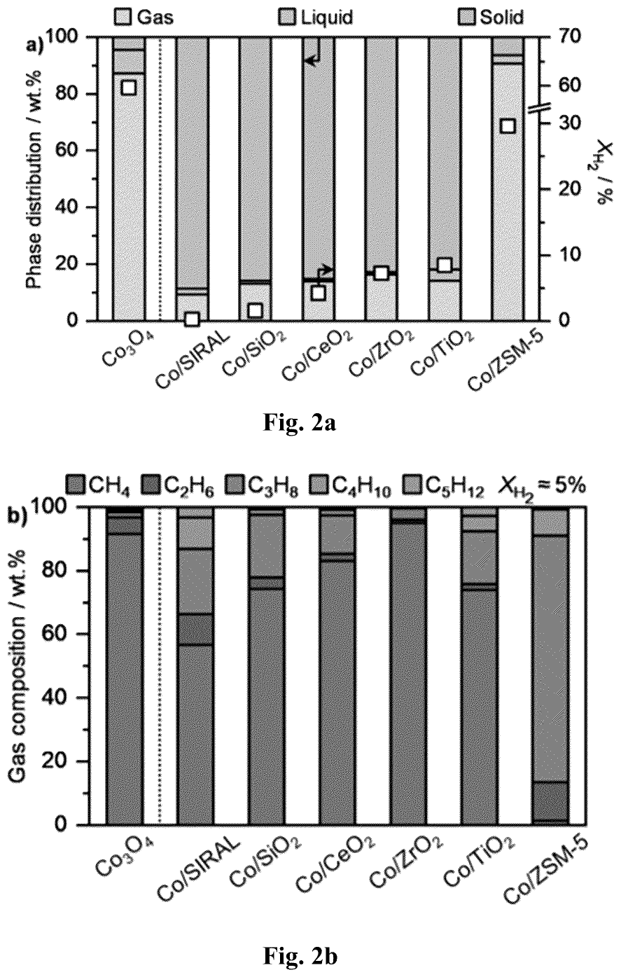

Support interactions have been shown to strongly affect the activity and selectivity of C—C bond cleavage over cobalt-based systems in different reactions. Thus, we dispersed 5 wt. % of cobalt over various supports, i.e., amorphous silica-alumina (SIRAL), silica (SiO₂), CeO₂, zirconia (ZrO₂), titania (TiO₂; anatase phase), and ZSM-5 zeolite (Si:Al ratio of 11.5) via incipient wetness impregnation. The catalysts were characterized by temperature-programmed reduction with H₂ (H₂-TPR), exhibiting at least two peaks at ca. 533 K and 603 K, similar to bulk Co₃O₄, which are characteristic of Co³⁺ and Co²⁺ reduction, respectively. Notable exceptions to this trend were Co/SIRAL and Co/ZSM-5, both showing a single peak at 533 K and 568 K, respectively. The catalysts were then tested in the batch solvent-free hydrogenolysis of model PE (M_{W}=4,000 Da) using an equivalent mass of cobalt across the experiments (FIG. 2). The catalytic activity was measured by quantifying the H₂ conversion, X_{H2}, which is a direct estimate of the numbers of C—C bonds cleaved. After 20 h at 523 K and 40 bar, differences were observed in the catalyst performance. In summary, the catalytic activity increased as: Co/SIRAL<Co/SiO₂<Co/CeO₂<Co/ZrO₂<Co/TiO₂<<Co/ZSM-5 (FIG. 2a). The reactivity hierarchy was well reflected by the phase distribution of products, with Co/SIRAL, Co/SiO₂, Co/CeO₂, Co/ZrO₂, and Co/TiO₂ predominantly resulting in solids (85-90%), while Co/ZSM-5 mainly yielded gaseous products (87%). Still, the H₂ conversion over Co/ZSM-5 was significantly lower than that obtained over Co₃O₄ under equivalent conditions (30% vs 60%).

The selectivity distributions in the gas phase were compared at X_{H2}≈5% (FIG. 2b), obtained by varying the reaction time. This allows for direct comparison of intrinsic selectivities normalized by an approximately equal number of C—C bonds cleaved. Co/ZrO₂ exhibited virtually a comparable gas-phase composition to that of bulk Co₃O₄. Co/TiO₂, Co/SiO₂, Co/CeO₂, and Co/SIRAL, conversely exhibited an increased formation of light alkanes, ranging from C₂H₆ to C₅H₁₂, although CH₄ remained the dominant product (FIG. 2b). Interestingly, at reduced H₂ conversions (≤1%) as obtained after 20 h, a considerably higher fraction of C₃H₈ and other light alkanes (60-90 wt. %) were detected over Co/SiO₂ and especially Co/SIRAL. However, the total gas yield was limited to approximately 15% and by increasing the H₂ conversion, the amount of CH₄ rose quickly at the expense of other alkanes (FIG. 2b). Notably, Co/ZSM-5 was the only system that did not produce CH₄ and instead favored the generation of C₃H₈ (77%), C₂H₆ (12%), and C₄H₁₀ (8%) at X_{H2}≈5%. Under these conditions, almost 30% of the products comprised liquid hydrocarbons (primarily pentane), while higher alkanes were significantly less abundant. The liquid distribution observed for Co/ZSM-5 strongly differs from that obtained over archetypical Ru/C that peaks at around C₁₆H₃₄. On the contrary, it qualitatively resembled that obtained over other cobalt-based catalysts, i.e., Co/SiO₂, Co/CeO₂, Co/SIRAL, although these systems generated considerably less liquids (<5 wt. %). These observations are consistent with the tendency of cobalt to cleave the polymer chain at terminal or close-to-terminal positions.
By progressively varying the reaction time from 5 to 80 h, the H₂ conversion over Co/ZSM-5 increased from ca. 7% to 42% along with the gas fraction (up to ca. 94%). Additionally, CH₄ selectivity rose with reaction time from 1% to 12% at the expense of C₃H₈ production, suggesting that CH₄ formation is kinetically limited. The cobalt-based catalysts were also tested in the batch solvent-free hydrogenolysis of model PP (M_{W}=12,000 Da). A comparable activity hierarchy to that in PE hydrogenolysis was observed when deconstructing PP: Co/SIRAL<Co/SiO₂<Co/CeO₂<Co/ZrO₂<Co/TiO₂<<Co/ZSM-5. Contrastingly, the H₂ conversions were lower, and the fraction of solids was higher when compared to those obtained for PE hydrogenolysis over the same systems, in agreement with the previous results on Co₃O₄. Yet, a similar product distribution to that in PE hydrogenolysis was observed, with Co/ZSM-5 favoring C₃H₈ formation (ca. 80%), while other systems preferably yielded CH₄.

We surmised the Brønsted acidity of the ZSM-5 zeolite might favor isomerization reactions and stabilize carbocations at tertiary carbon positions, leading to their preferential cleavage. Accordingly, Co/ZSM-5, together with Co/SiO₂ and Co/SIRAL, were further characterized by temperature-programmed desorption of NH₃. While Co/SiO₂ is not acidic, Co/ZSM-5 and Co/SIRAL showed two similar main peaks for NH₃ desorption (423 K, 778 K vs 393 K, 723 K), indicating qualitatively similar acidic strength, although differing in total quantity of sites (0.87 mmol_{NH3} g_{cat}⁻¹ vs 0.04 umol_{NH3} g_{cat}⁻¹), respectively. The acidity in SIRAL and ZSM-5 supports may play a role in promoting non-terminal C—C bond cleavage, as evidenced by the high propane selectivities at low conversions (60% vs 80%). But as the reaction progresses (X_{H2}≥5%), the selectivity is maintained over the ZSM-5 support and decreases over SIRAL (˜20%) at the expense of methane. This suggests that other factors beyond acidity are responsible for the observed performance.

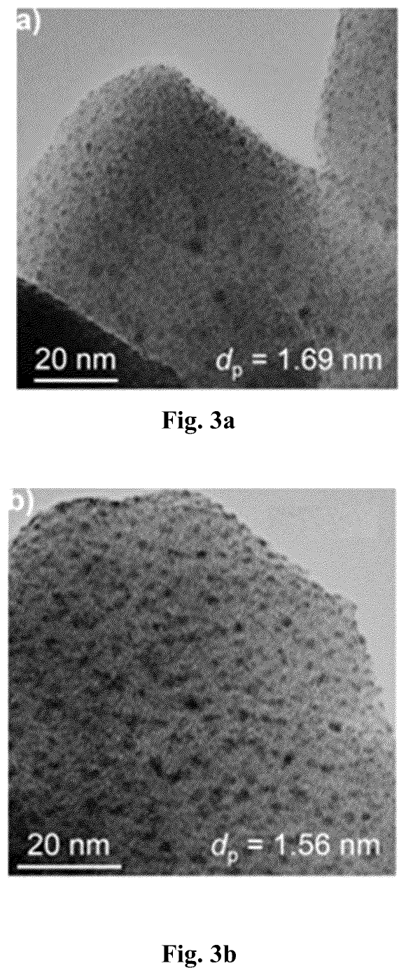

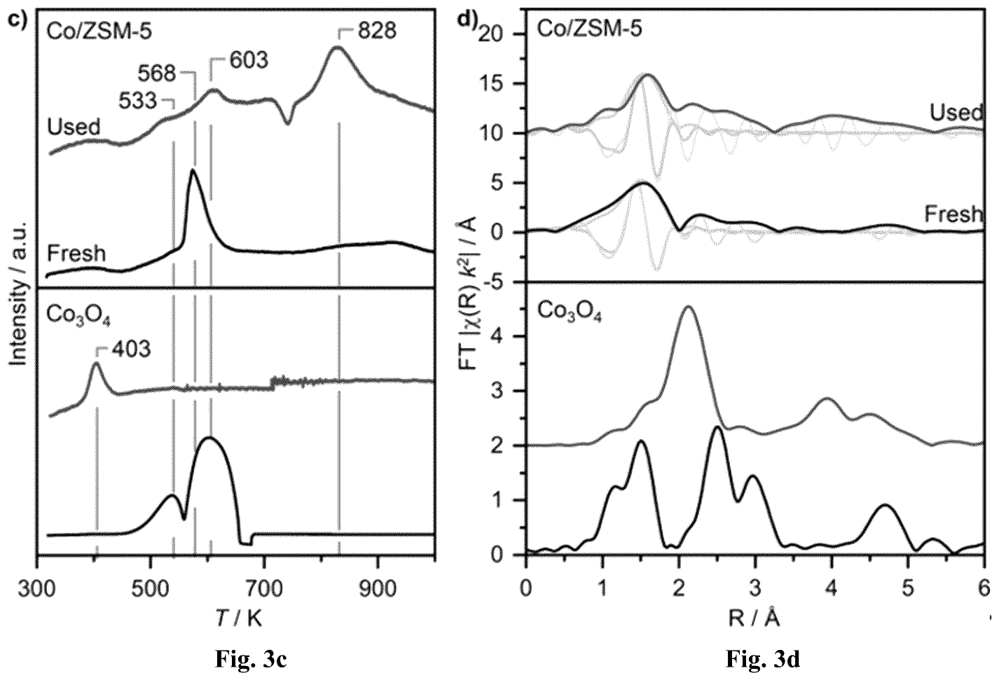

Co/ZSM-5 was further analyzed by transmission electron microscopy (TEM) prior to and after PE hydrogenolysis. The micrographs evidenced uniform cobalt nanoparticle dispersion across the support both before and after reaction, with an average particle size of 1.69±0.35 nm and of 1.56±0.28 nm, respectively (FIGS. 3a, 3b). The choice of the support has been shown to significantly influence the oxidation state of cobalt, allowing the stabilization of either metallic or partially reduced phases in H₂-rich atmospheres. It has been shown that metal confinement within zeolites can stabilize metastable phases, which could offer a possible explanation for the pronounced stabilization effect with ZSM-5. Interestingly, Have et al. demonstrated that H₂ activation routes differ depending on the cobalt oxidation state in CO₂-based Fischer-Tropsch synthesis. In particular, they showed that while H₂ is adsorbed dissociatively over metallic cobalt, cobalt oxide follows an H₂-assisted pathway. On these bases, we posit that the observed shift from mainly terminal to close-to-terminal C—C bond cleavage in polyolefin hydrogenolysis over Co/ZSM-5 might stem from the preferential stabilization of cobalt oxide phases in the zeolite that are different from those observed for bulk Co₃O₄ or other supports under reductive conditions.

To test this hypothesis, we conducted ex situ H₂-TPR as well as X-ray absorption spectroscopy (XAS) at the Co K-edge of Co/ZSM-5 and Co₃O₄ after PE hydrogenolysis and compared it to the corresponding data in fresh form (FIGS. 3c, 3d). Analysis of the X-ray absorption near edge structure (XANES) revealed that, while fresh Co₃O₄ featured the expected mixed Co²⁺ and Co³⁺ oxidation states, the white line and edge position of the Co/ZSM-5 spectrum resembles that of highly dispersed Co²⁺ species. Notably, the H₂-TPR profile of the spent Co/ZSM-5 showed new peaks at 603 K and 828 K (FIG. 3c), indicating the presence of species that are less reducible. These data are consistent with the XANES profiles of spent Co/ZSM-5 showing the preservation of Co²⁺ species, as well with the FT-EXAFS analysis that showed unchanged local coordination environments after reaction, with the first peak centered at 1.61 Å to be that of Co—O as confirmed by EXAFS analysis. Still, differences in intensity and broadening of the pre-edge XANES region were observed between the spectra of fresh and used Co/ZSM-5, suggesting changes in the coordination geometry. Contrarily, there was extensive reduction of the Co₃O₄ during PE hydrogenolysis, as observed both by H₂-TPR (FIG. 3c) and by XAS, which detected almost exclusively metallic cobalt species with the main peak centered at 2.15 Å (not phase corrected) ascribed to Co—Co pairs (FIG. 3d). Finally, TEM and XAS were also conducted on Co/SiO₂ prior to and after PE hydrogenolysis. These analyses revealed that this catalyst was composed of large clusters (dₚ≈17 nm) of Co₃O₄ that reduced to CoO-like species upon reaction. These results suggest that the stabilization of highly dispersed oxidic cobalt nanoparticles in the zeolite prevent complete reduction to metallic species and/or formation of large clusters, which may be related to the observed promotion of C₃H₈ and suppression of CH₄.

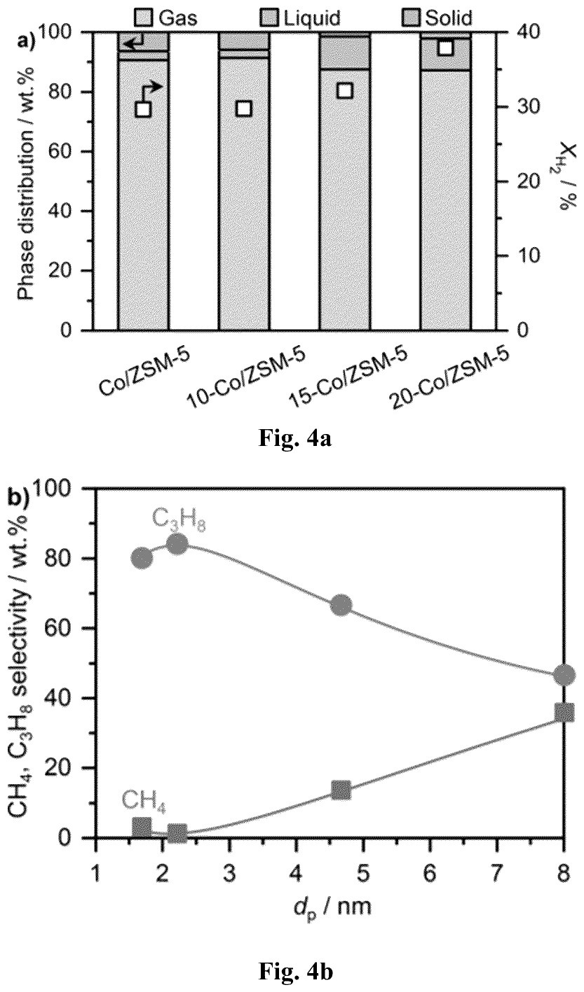

ZSM-5-supported cobalt catalysts with different metal loading, i.e., 10, 15, and 20 wt. %, were further synthesized via incipient wetness impregnation and compared against 5 wt. % Co/ZSM-5 in PE hydrogenolysis at equivalent temperature, pressure, time, and cobalt loading (FIG. 4a). In particular, while H₂ conversion remained similar over both Co/ZSM-5 and 10-Co/ZSM-5 (˜29%), it increased over 15-Co/ZSM-5 (32%) and further over 20-Co/ZSM-5 (38%). While the gas fraction remained roughly constant over the catalysts at ca. 87%, differences were observed in the remaining products. Solids were the main by-products over Co/ZSM-5 and 10-Co/ZSM-5, while liquids, primarily composed of pentane, were observed over 15-Co/ZSM-5 and 20-Co/ZSM-5. Yet, the most striking difference was found in the composition of the gaseous components; namely, while Co/ZSM-5 and 10-Co/ZSM-5 maintained high selectivity values towards C₃H₈ (˜84%), this value decreased over 15-Co/ZSM-5 (66%) and especially 20-Co/ZSM-5 (47%) at the benefit of CH₄ (14% vs 36%).

To gain insights into this phenomenon, we performed TEM and H₂-TPR of these systems in fresh form. The micrographs of 10-Co/ZSM-5 evidenced well-dispersed particles with a relatively narrow particle size distribution centered around 2.22±0.46 nm. The H₂-TPR profile of 10-Co/ZSM-5 showed a main peak at 578 K, comparable to Co/ZSM-5 (5 wt. %), with a small shoulder at 533 K. The similar morphology and reducibility of the 5 wt. % and 10 wt. % loaded systems is consistent with their analogous catalytic performance. Conversely, 15-Co/ZSM-5 and particularly 20-Co/ZSM-5 showed large ˜30 nm clusters deposited on the external surface of the zeolite together with small nanoparticles dispersed in the microporous structure, resulting in broad particle size distributions of: 4.67±3.30 nm over 15-Co/ZSM-5 and 8.01±5.32 nm over 20-Co/ZSM-5. Their H₂-TPR profiles exhibited a main peak at 578 K, similar to those observed over Co/ZSM-5 and 10-Co/ZSM-5 that were attributed to the presence of small nanoparticles in the zeolite, as well as shoulders at 533 K and 603 K likely associated with large clusters of Co₃O₄. The latter would explain both the increased reactivity and the shift toward CH₄ formation. The dependency of the C₃H₈ and CH₄ selectivity on the average particle size, dₚ, is depicted in FIG. 4b. The generation of C₃H₈ and CH₄ followed a volcano and anti-volcano behavior with a maximum at 84% and minimum at 1%, respectively, both centered around 2.22 nm obtained over 10-Co/ZSM-5.

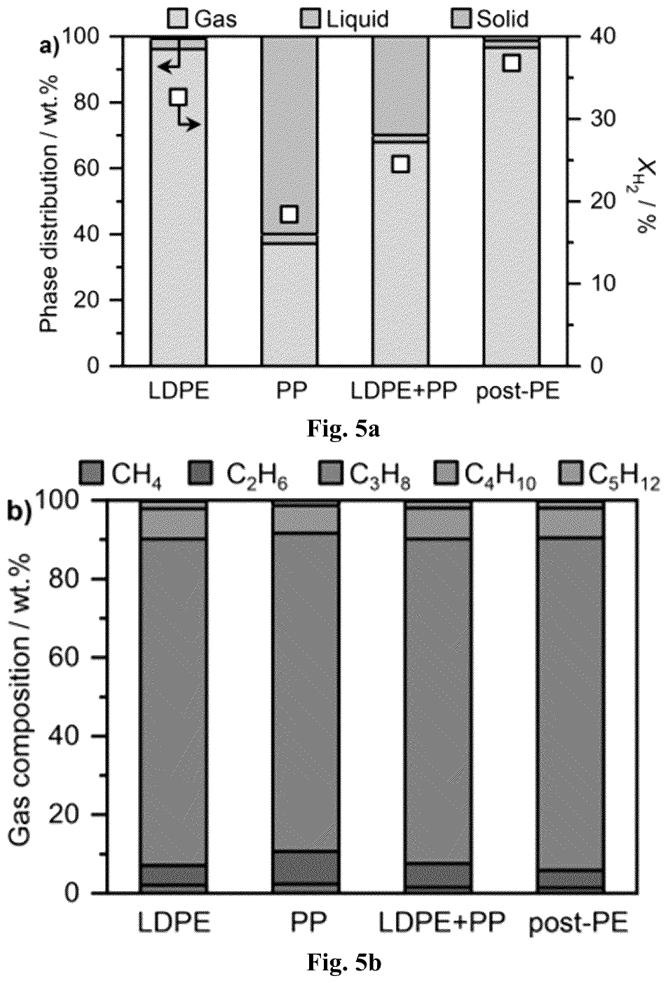

Finally, the best-performing catalyst, 10-Co/ZSM-5, was tested in the solvent-free hydrogenolysis of polyolefins representative of plastic waste: low-density PE (LDPE), PP (M_{W}=12,000 Da), a weight-equivalent mixture of LDPE and PP, as well as a post-consumer PE bottle (post-PE) from VWR International (FIG. 5). High H₂ conversion (X_{H2}≥35%) was reached in LDPE and post-PE hydrogenolysis over 10-Co/ZSM-5, leading to gases (ca. 95%). On the contrary, X_{H2} decreased to 25% and 18% in the hydrogenolysis of the LDPE+PP mixture and PP, resulting in a higher solid fraction (ca. 30% and 60%), respectively, compared to LDPE alone and post-PE (<3%; FIG. 5a), probably due to the lower reactivity of PP. In all cases, liquids were limited to ≤5 wt. % and were composed primarily of pentane, as observed in PE hydrogenolysis over Co/ZSM-5. C₃H₈ was preferably formed in all tests with selectivity values of ca. 80% selectivity (FIG. 5b).

In conclusion, we demonstrated ZSM-5-supported cobalt-based catalysts as highly efficient systems for the selective conversion of PE and PP into C₃H₈ (up to 84%), with a balance of other light alkanes including C₂H₆ and C₄H₁₀. By applying commercial dehydrogenation technologies, these alkanes could be readily converted into the corresponding olefins and H₂, closing both the carbon and hydrogen loop in production and regeneration cycle of these polyolefins. The performance of Co/ZSM-5 significantly differed from that of bulk Co₃O₄ as well as of other cobalt-based systems supported on other carriers, which led to the almost exclusive formation of CH₄ (up to 95%). The ability to shift from terminal C—C bond cleavage to cleavage at regular intervals in the internal polymer backbone was ascribed to the stabilization of dispersed oxidic cobalt nanoparticles. Further, the cobalt loading was varied, which revealed a volcano and anti-volcano behavior of the C₃H₈ and CH₄ selectivity with the particle size, respectively. In particular, C₃H₈ production peaked at 2.22 nm over 10-Co/ZSM-5, while it decreased until ca. 30% over 20-Co/ZSM-5 at the benefit of CH₄. This behavior was ascribed to the progressive accumulation of large Co₃O₄ clusters (up to 30 nm) with cobalt loading on the external zeolite surface. After optimizing the metal loading, we demonstrate that 10 wt. % Co/ZSM-5 can selectively catalyze the solvent-free hydrogenolysis of low-density PE (LDPE), mixtures of LDPE and PP, as well as post-consumer PE.

The process disclosed herein uses a catalyst comprised of cobalt to catalyze the cleave of carbon-carbon bonds in polyolefins in the presence of hydrogen gas in a batch reactor at moderate temperatures such as 523 K. In some embodiments, the temperature range is from 300 K to 600 K. In some embodiments, the temperature range in the reaction vessel is from 350 K to 550 K. In some embodiments, the temperature range is from 300 K to 600 K, 325 K to 600 K, 350 K to 600 K, 400 K to 600 K, 450 K to 600 K, 450 K to 550 K, or 500 K to 600 K, or 500 K to 550.

In some embodiments, the residence time in the reaction vessel is 30 minutes to 30 hours or more than 60 hours. In some embodiments the residence time in the reaction vessel is 30 minutes to 60 hours, 1-51 hours, 5-55 hours, 5-50 hours, 10-50 hours, 20-50 hours, 20-45 hours, 20-40 hours.

In some embodiments, the residence time in the reaction vessel is 30 hours, 35 hours, 40 hours, 45 hours, 50 hours, 55 hours, 60 hours, 65 hours, 70 hours, or 75 hours.

It should be understood that the subject matter defined in the appended claims is not necessarily limited to the specific implementations described above. The specific implementations described above are disclosed as examples only.

### Example 1—Tunable Catalytic Systems for Selective Plastic Depolymerization

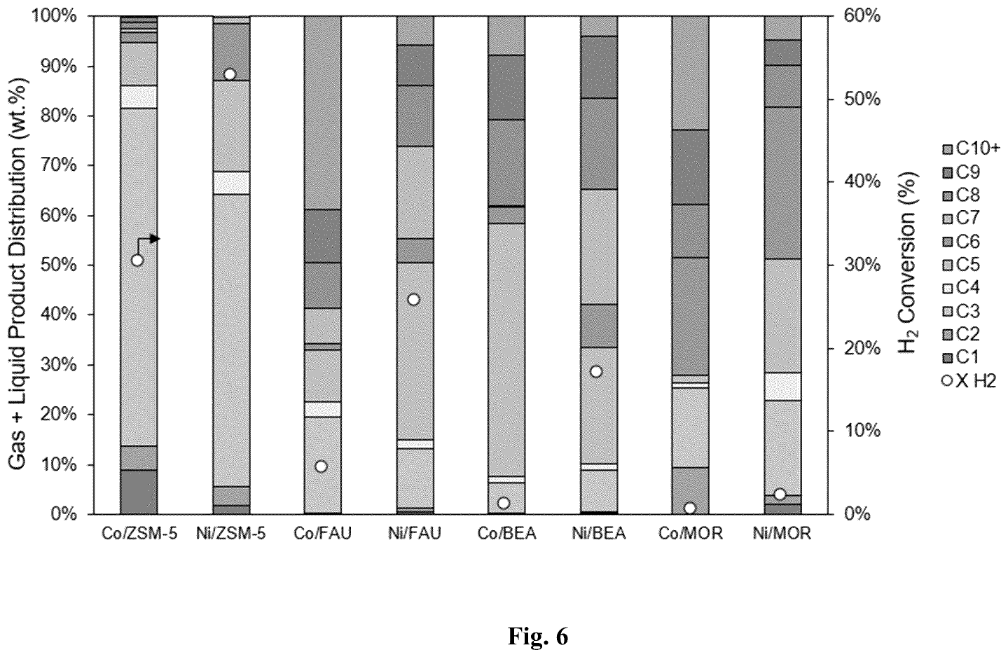

Catalysts comprised of 10 wt. % cobalt and nickel supported on a variety of zeolite frameworks were studied in order to probe the activity and selectivity differences of metals and the support frameworks. Commercial zeolite varieties including ZSM-5, FAU, BEA, and MOR were used to study a wide array of zeolite topology ranging from small to large pore sizes with similar Si/Al ratios (˜12.5). FIG. 6 presents the gas and liquid products after 20-hour reaction at 250° C. and 40 Bar H₂. A large difference in hydrogen activity (proxy to determine amount of external hydrogen used to cleave C—C bonds) is seen between the different metals supported on the same framework. Nickle systems are ˜15-20% more active than the cobalt system on the same support (excluding mordenite framework which has very little activity). Catalyst activity over the 20-hour period was shown to increase as MOR<BEA<FAU<ZSM-5. High selectivity to propane was achieved over the ZSM-5 framework where Ni also showed an increased selectivity towards C5 products. The C3 and C5 selectivity could be a function of the location where the chain undergoes isomerization and subsequent β-scission (terminal tertiary carbocation isomerization would result in high propane selectivity). Preliminary results with hexadecane as a model compound for PE demonstrate the ability of Co/ZSM-5 to produce high yields of C3 with minimal production of C14 and C15, indicating the possibility of a terminal cleavage mechanism.

For the same 10 wt. % cobalt and nickel catalysts, a comparison between ZSM-5 and SiO₂ supports was performed at the same reaction conditions. The ZSM-5 systems resulted in much higher hydrogen conversion, 30% and 40% for cobalt and nickel respectively, suggesting the importance of the acid sites for C—C bond cleavage in accordance with literature. Co supported on SiO₂ was fairly inactive at 1% H₂ conversion, whereas Ni/SiO₂ was slightly more active (9% H₂ conversion), producing primarily propane and pentane.

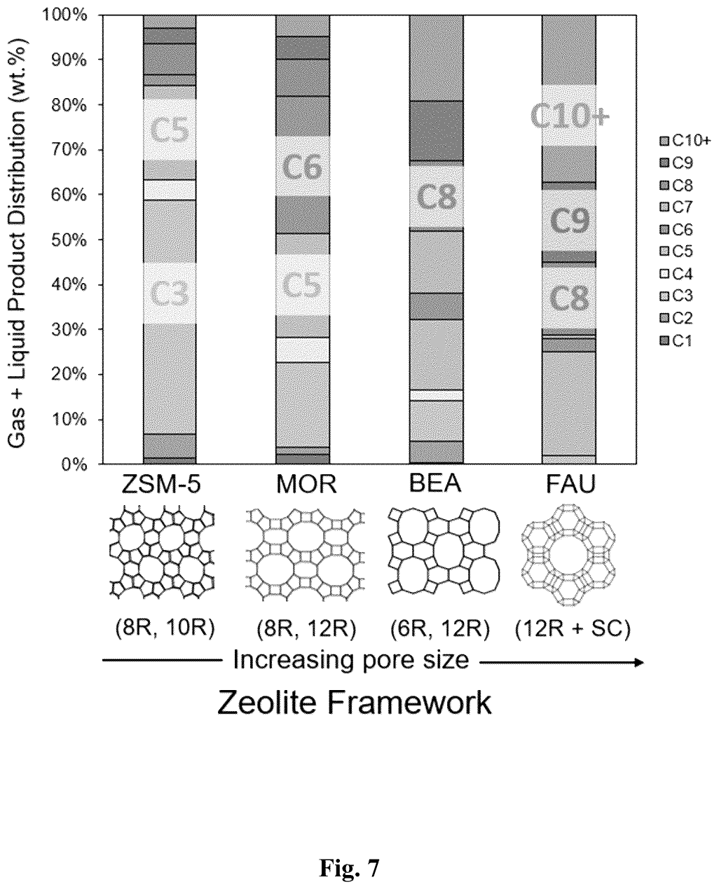

In order to determine inherent catalyst selecitivies, the same 10 wt. % nickel+zeolite systems were compared at similar hydrogen conversions. As product distributions can change as a function of conversion, any important distinctions between catalysts and/or product selectivities need to be determined at the same conversion (in this case, amount of external hydrogen used to cleave C—C bonds). Reaction times were varied in order to achieve comparable hydrogen conversions and the resulting product distributions are shown in FIG. 7. The smallest pore zeolite, ZSM-5 (made of 8- and 10-membered rings) produced primarly C3 and C5 products. Mordenite, consisting of 8- and 12-membered rings, showed a higher carbon number selectivity (favoring C5 and C6 products). This trend continues with zeolite beta, showing higher selectivity towards C7-C9 products. It is important to note that while beta is made of both 6- and 12-membered rings, the 6-membered rings is too small and diffusion is controlled via the 12-membered ring. Finally, the large pore zeolite faujasite, composed of 12-membered rings and a super cage, favored the largest carbon number (C8+) products. This demonstrates the ability of the zeolite framework to selectively tune product distributions.

### Additional Examples

Example 1. A method for depolymerizing polyolefins, comprising
preparing a catalyst comprising cobalt, nickel or both;
combining the catalyst with a sample comprising polyolefins in a reaction vessel in the presence of H₂ gas to produce a mixture, wherein the polyolefin comprises a carbon chain having the structure (CH₂CHR)ₙ wherein R is an alkyl group and n is an integer greater than 20;
reacting the mixture under conditions effective to depolymerize the polyolefins to produce decomposition products, wherein the decomposition products comprise the structure (CH₂CHR)ₘ wherein m is an integer much less than n.

Example 2. The method of example 1, wherein the sample comprises plastic material.

Example 3. The method of example 2, wherein the plastic material comprises at least one product selected from the group consisting of plastic film, plastic foam, plastic packaging, plastic bags, plastic wrap, and combinations thereof.

Example 4. The method of any one of examples 2-3, wherein the plastic material comprises polyethylene or polypropylene.

Example 5. The method of any one of examples 1-4, wherein the decomposition products comprise a carbon chain having the structure (CH₂CH₂)ₘ.

Example 6. The method of any one of examples 1-5, wherein the decomposition products comprise a carbo chain having the structure (CH₂CH(CH₃))ₘ.

Example 7. The method of any one of examples 1-6, wherein the decomposition products consist of a high selectivity towards selected light alkanes.

Example 8. The method of any one of examples 1-7, wherein more than 50%, 60%, 70%, or 80% of the decomposition products comprise a carbon chain having the structure (CH₂CH₂)ₘ.

Example 9. The method of any one of examples 1-8, wherein the more than 50%, 60%, 70%, or 80% of the decomposition products comprise a carbon chain having the structure (CH₂CH(CH₃))ₘ.

Example 10. The method of any one of examples 1-9, wherein the decomposition products comprise up to 84% C₃H₈.

Example 11. The method of any one of examples 1-10, wherein less than 30%, 25%, 20%, 25%, 15%, or 10% of the decomposition products consist of methane.

Example 12. The method of any one of examples 1-11, wherein the catalyst comprises cobalt supported by a zeolite carrier.

Example 13. The method of any one of examples 1-12, wherein the catalyst comprises cobalt supported by a pentasil-zeolite carrier.

Example 14. The method of any one of examples 1-13, wherein the catalyst comprises nickel supported by a zeolite carrier.

Example 15. The method of any one of examples 1-14, wherein the catalyst comprises nickel supported by a pentasil-zeolite carrier.

Example 16. The method of any one of examples 1-15, wherein the catalyst comprises ZSM-5.

Example 17. The method of any one of examples 1-16, wherein the catalyst is

Co/ZSM selected from the group consisting of Co/ZSM-5 and 10-Co/ZSM-5,15-Co/ZSM-5, and 20-Co/ZSM-5

Example 18. The method of any one of examples 1-17, wherein the conditions effective to depolymerize the polyolefins to produce decomposition products comprise a temperature range of 300-600 K.

Example 19. The method of any one of examples 1-18, wherein the conditions effective to depolymerize the polyolefins to produce decomposition products comprise a temperature range of 400-600 K.

Example 20. The method of any one of examples 1-19, wherein the conditions effective to depolymerize the polyolefins to produce decomposition products comprise a temperature range of 500-600 K.

Example 21. The method of any one of examples 1-20, wherein the conditions effective to depolymerize the polyolefins to produce decomposition products comprise a temperature of 523 K.

Example 22. The method of any one of examples 1-21, wherein the conditions effective to depolymerize the polyolefins to produce decomposition products comprise an initial H₂ pressure of 1-100 bar.

Example 23. The method of any one of examples 1-22, wherein the conditions effective to depolymerize the polyolefins to produce decomposition products comprise an initial H₂ pressure of 10-100 bar.

Example 24. The method of any one of examples 1-23, wherein the conditions effective to depolymerize the polyolefins to produce decomposition products comprise an initial H₂ pressure of 20-60 bar.

Example 25. The method of any one of examples 1-24, wherein the conditions effective to depolymerize the polyolefins to produce decomposition products comprise an initial H₂ pressure of 30-50 bar.

Example 26. The method of any one of examples 1-25, wherein the conditions effective to depolymerize the polyolefins to produce decomposition products comprise a batch process with a residence time in the reaction vessel of 1-100 hours.

Example 27. The method of any one of examples 1-26, wherein the conditions comprise a batch process with a residence time in the reaction vessel of 5-50 hours.

Example 28. The method of any one of examples 1-27, wherein the conditions effective to depolymerize the polyolefins to produce decomposition products comprise a continuous process.

Example 29. The method of example 28, wherein the continuous process comprises a continuous addition of sample to the reaction vessel in (b) and a continuous removal of the decomposition products in (c).

Example 30. The method of any one of examples 1-29, further comprising isolating the decomposition products.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, are disclosed separately. When a Markush group or other grouping is used herein, all individual members of the group and all combinations and subcombinations possible of the group are intended to be individually included in the disclosure. For example, when a device is set forth disclosing a range of materials, device components, and/or device configurations, the description is intended to include specific reference of each combination and/or variation corresponding to the disclosed range.

Every formulation or combination of components described or exemplified herein can be used to practice the invention, unless otherwise stated.

Whenever a range is given in the specification, for example, a density range, a number range, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter is claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A method for depolymerizing polyolefins, comprising
a. preparing a catalyst comprising cobalt, nickel or both;
b. combining the catalyst with a sample comprising polyolefins in a reaction vessel in the presence of H₂ gas to produce a mixture, wherein the polyolefin comprises a carbon chain having the structure (CH₂CHR)ₙ wherein R is an alkyl group and n is an integer greater than 20;
c. reacting the mixture under conditions effective to depolymerize the polyolefins to produce decomposition products, wherein the decomposition products comprise the structure (CH₂CHR)ₘ wherein m is an integer much less than n.

2. The method of claim 1, wherein the sample comprises plastic material comprising at least one product selected from the group consisting of plastic film, plastic foam, plastic packaging, plastic bags, plastic wrap, and combinations thereof.

3. The method of any one of claims 2-3, wherein the plastic material comprises polyethylene or polypropylene.

4. The method of claim 1, wherein the decomposition products comprise a carbon chain having the structure (CH₂CH₂)ₘ.

5. The method of claim 1, wherein the decomposition products comprise a carbo chain having the structure (CH₂CH(CH₃))ₘ.

6. The method of claim 1, wherein the decomposition products consist of a high selectivity towards selected light alkanes.

7. The method of claim 1, wherein more than 50% of of the decomposition products comprise a carbon chain having the structure (CH₂CH₂)ₘ.

8. The method of claim 1, wherein the more than 50% of the decomposition products comprise a carbon chain having the structure (CH₂CH(CH₃))ₘ.

9. The method of claim 1, wherein the decomposition products comprise up to 84% C₃H₈.

10. The method of claim 1, wherein the catalyst comprises cobalt or nickel supported by a zeolite carrier.

11. The method of claim 1, wherein the catalyst comprises cobalt or nickel supported by a pentasil-zeolite carrier.

12. The method of claim 1, wherein the catalyst comprises greater than 5 wt % cobalt and greater than 5 wt % nickel.

13. The method of claim 1, wherein the catalyst comprises ZSM-5.

14. The method of claim 1, wherein the catalyst is Co/ZSM selected from the group consisting of Co/ZSM-5 and 10-Co/ZSM-5,15-Co/ZSM-5, and 20-Co/ZSM-5.

15. The method of claim 1, wherein the conditions effective to depolymerize the polyolefins to produce decomposition products comprise a temperature range of 300-600 K.

16. The method of claim 1, wherein the conditions effective to depolymerize the polyolefins to produce decomposition products comprise a temperature of 523 K.

17. The method of claim 1, wherein the conditions effective to depolymerize the polyolefins to produce decomposition products comprise an initial H₂ pressure of 20-60 bar.

18. The method of claim 1, wherein the conditions effective to depolymerize the polyolefins to produce decomposition products comprise a continuous process.

19. The method of claim 18, wherein the continuous process comprises a continuous addition of sample to the reaction vessel in (b) and a continuous removal of the decomposition products in (c).

20. The method of claim 1, further comprising isolating the decomposition products.
